(19) United States
(12) Patent Application Publication
(10) Pub. No.: US 2019/0002302 A1
(43) Pub. Date: Jan. 3, 2019

(54) Hydrate of Rare Earth Metal Sulfate, Method for Producing Same, and Chemical Thermal Storage Material

(71) Applicant: Kyoto University, Sakyo-ku, Kyoto-shi (JP)

(72) Inventors: Naoyuki Hatada, Kyoto (JP); Tetsuya Uda, Kyoto (JP)

(73) Assignee: Kyoto University, Kyoto (JP)

(21) Appl. No.: 16/060,118

(22) PCT Filed: Dec. 8, 2016
(86) PCT No.: PCT/JP2016/086634

§ 371 Date: Jun. 7, 2018

(30) Foreign Application Priority Data
Dec. 10, 2015 (JP) 2015-241182

(51) Int. Cl. C01F 17/00

(52) U.S. Cl. CPC C01F 17/0081; C01P 2002/72; C01P 2002/88

(57) ABSTRACT

An object of the present invention is to provide an inexpensive and highly safe compound useful as a chemical heat storage material that ensures high reproducibility even in repeated reactions (having high repetition durability), and is capable of reversibly advancing heat storage and heat dissipation even in a relatively low temperature range. The present invention is a hydrate of a rare earth metal sulfate having characteristic peaks at specific diffraction angles (2θ) in an X-ray diffraction pattern, which is measured using a copper radioactive ray of λ=1.5418 Å passed through a monochromator.

The present invention relates to a hydrate of a rare earth metal sulfate, a method for producing the same, and a chemical heat storage material.

### BACKGROUND ART

Currently, a large amount of waste heat, of about 100 to 250° C., is discarded in industrial plants and the like in Japan. It is believed that the storage and effective use of such waste heat will result in effective energy use, thereby reducing the consumption of fossil fuels.

From the above viewpoint, the development of heat storage technology has heretofore been promoted. As an example of such technology, a latent heat storage technology that utilizes the latent heat of fusion of an organic heat storage material has been developed; however, this technology is costly because of the small heat storage density (see, for example, NPL 1).

In contrast, a chemical heat storage technology using a chemical reaction, which is advantageous in terms of heat storage density, has also been developed. For example, the development of a solid/gas reaction system, such as the one shown in Table 1, has been considered in order to produce a reaction system capable of heat storage and heat supply at a temperature range of about 100° C. or more. Table 1 lists systems using water vapor as a gas component, which are advantageous in terms of safety and versatility.

TABLE 1

| | | Equilibrium Temperature |
|---|---|---|
| | Reaction System | (° C.) |
| Reaction System 1 | CoO/H₂O | 97 |
| Reaction System 2 | FeO/H₂O | 100 |
| Reaction System 3 | CuO/H₂O | 158 |
| Reaction System 4 | MgO/H₂O | 269 |
| Reaction System 5 | LaOOH/H₂O | 290 |
| Reaction System 6 | CaO/H₂O | 521 |

Reaction systems 1 to 3 in Table 1 are prospective systems in terms of their relatively low equilibrium temperatures; however, hydration reactions, i.e., reverse reactions, hardly proceed in these systems, and heat cannot be supplied. Therefore, these systems cannot be considered industrially effective reaction systems. In addition, since the CuO used in reaction system 3 is expensive, it is also problematic in terms of the high cost.

In reaction systems 4 to 6, the reactions reversibly proceed; further, reaction systems 4 to 6 can be regarded as relatively promising in terms of low cost, safety, and noncorrosive property. However, as is clearly shown in Table 1, the temperature during the heat storage operation (dehydration reaction) is higher than 250° C. in reaction systems 4 to 6. Further, reaction system 4 is problematic in terms of the durability in repeated use.

As is clear from the above, practical use of the materials for chemical heat storage has thus far been unsuccessful (see NPL 2 regarding the MgO/H₂O of reaction system 4, and NPL 3 regarding the LaOOH/H₂O of reaction system 5).

### CITATION LIST

### Non-Patent Literature

NPL 1: Shikata, Iwai, Energy and Resources, 29 (2008) 88.
NPL 2: Ryu, J. Soc. Inorg. Mater. Jpn. 20 (2013) 55.
NPL 3: H. Ishitobi et al., Chem. Lett., 41 (2012) 583.

### SUMMARY OF INVENTION

### Technical Problem

An object of the present invention is to provide a compound useful as a chemical heat storage material, which is inexpensive, highly safe, ensures high reproducibility even in repeated reactions (having high repetition durability), and is capable of reversibly advancing heat storage and heat dissipation even in a relatively low temperature range.

### Solution to Problem

The inventors of the present invention conducted extensive research to solve the above problems, and found that a hydrate of a specific rare earth metal sulfate enables reversible dehydration/hydration reactions at a low temperature range, i.e., about 100 to 250° C. With this finding, the inventors completed the present invention.

The present invention was completed based on such a finding. The present invention relates to the following hydrates of rare earth metal sulfate, production methods thereof, and chemical heat storage materials, shown in Items 1 to 10 below.

Item 1. A hydrate of a rare earth metal sulfate having characteristic peaks at the following diffraction angles (2θ) in an X-ray diffraction pattern, which is measured using a copper radioactive ray of λ=1.5418 Å passed through a monochromator.

Diffraction angles (2θ)
13.0 to 14.0°
16.5 to 17.5°
19.5 to 20.5°
24.5 to 25.5°
29.0 to 30.0°
   Item 2. The hydrate of a rare earth metal sulfate according to Item 1, wherein the rare earth metal is at least one member selected from the group consisting of lanthanum, cerium, praseodymium, neodymium, and yttrium.
   Item 3. The hydrate of a rare earth metal sulfate according to Item 1 or 2, represented by general formula (1):

M₂(SO₄)₃.nH₂O (1)
(in formula (1), M is at least one rare earth metal selected from the group consisting of La, Ce, Pr, Nd, and Y; n is greater than 0, and not more than 9).
   Item 4. The hydrate of a rare earth metal sulfate according to any one of Items 1 to 3, wherein the hydrate of a rare earth metal sulfate is a monohydrate of a rare earth metal sulfate.
   Item 5. A hydrate of a rare earth metal sulfate, represented by general formula (2):

M₂(SO₄)₃.1H₂O (2)
(in formula (2), M is at least one rare earth metal selected from the group consisting of La, Ce, Pr, Nd, and Y).
   Item 6. A chemical heat storage material comprising the hydrate of a rare earth metal sulfate according to any one of Items 1 to 5, and further comprising a rare earth metal sulfate having characteristic peaks at the following diffraction angles (2θ) in an X-ray diffraction pattern, which is measured using a copper radioactive ray of λ=1.5418 Å passed through a monochromator.

Diffraction angles (2θ)
13.0 to 14.0°
16.5 to 17.5°
19.5 to 20.5°
24.5 to 25.5°
29.0 to 30.0°
   Item 7. A method for producing a hydrate of a rare earth metal sulfate having characteristic peaks at the following diffraction angles (2θ) in an X-ray diffraction pattern, which is measured using a copper radioactive ray of λ=1.5418 Å passed through a monochromator, the method comprising:

step (1) of heating a rare earth metal sulfate, or a hydrate of a rare earth metal sulfate that does not have the peaks, to 200° C. or more; and

step (2) of lowering the temperature of the rare earth metal sulfate obtained in step (1) in the presence of water vapor.

Diffraction angles (2θ)
13.0 to 14.0°
16.5 to 17.5°
19.5 to 20.5°
24.5 to 25.5°
29.0 to 30.0°
   Item 8. A method for producing a monohydrate of a rare earth metal sulfate, comprising:

step (1) of heating a rare earth metal sulfate, or a hydrate of a rare earth metal sulfate that does not have characteristic peaks at the diffraction angles (2θ) specified in Item 7 in an X-ray diffraction pattern, which is measured using a copper radioactive ray of λ=1.5418 Å passed through a monochromator, to 200° C.; and

step (2) of lowering the temperature of the rare earth metal sulfate obtained in step (1) in the presence of water vapor.

Item 9. The method according to Item 7 or 8, wherein the rare earth metal is at least one member selected from the group consisting of lanthanum, cerium, praseodymium, neodymium, and yttrium.

### Advantageous Effects of Invention

The hydrate of a rare earth metal sulfate of the present invention undergoes reversible dehydration/hydration reactions at a low temperature range, i.e., about 100 to 250° C. Further, the cost of the hydrate of a rare earth metal sulfate of the present invention is low, since the rare earth metals to be used in this invention are relatively inexpensive. Moreover, the hydrate of a rare earth metal sulfate of the present invention ensures significantly high reproducibility in the reversible reactions; i.e., it ensures high repetition durability. Therefore, the hydrate of a rare earth metal sulfate of the present invention is significantly useful as an industrially applicable chemical heat storage material. For example, it enables storage and effective use of a part of the industrial waste heat. The present invention is thus expected to contribute to reduction in consumption of fossil fuels.

### BRIEF DESCRIPTION OF DRAWINGS

FIG. 1: Results (TG-DTA curve) of thermogravimetry (TG) measurement of lanthanum sulfate in Reference Example 1.

FIG. 2: X-ray diffraction patterns of the lanthanum sulfate prepared in Reference Example 2 at different temperatures.

FIG. 3: Results (TG-DTA curve) of thermogravimetry (TG) measurement of lanthanum sulfate and lanthanum sulfate hydrate in Example 1.

FIG. 4: Results (TG curve) of thermogravimetry (TG) measurement of lanthanum sulfate and lanthanum sulfate hydrate in Example 1, when a temperature increasing/lowering step is repeated 35 times.

FIG. 5: X-ray diffraction patterns of lanthanum sulfate and lanthanum sulfate hydrate measured at different temperatures in Example 2.

FIG. 6: Results (TG-DTA curve) of thermogravimetry (TG) measurement of lanthanum sulfate and lanthanum sulfate hydrate in Example 3.

FIG. 7: Results (TG curve) of thermogravimetry (TG) measurement of lanthanum sulfate and lanthanum sulfate hydrate in Example 4.

FIG. 8: A graph plotting a relationship between partial water vapor pressure and dehydration temperature, for each hydration number (x), obtained from the results of TG measurement in FIG. 7.

FIG. 9: Results (TG-DTA curve) of thermogravimetry (TG) measurement of cerium sulfate and cerium sulfate hydrate in Example 5.

FIG. 10: Results (TG-DTA curve) of thermogravimetry (TG) measurement of MgO/H₂O system in Comparative Example 1.

FIG. 11: A schematic diagram showing a device used in Example 6.

FIG. 12: A graph showing temperature change of a sample over time after humidified air (water vapor) is supplied.

FIG. 13: A schematic diagram showing a device used in Example 7.

FIG. 14: A graph showing temperature change of a sample over time after water (liquid) is supplied.

### DESCRIPTION OF EMBODIMENTS

Examples of the rare earth metal constituting the hydrate of a rare earth metal sulfate of the present invention include at least one member selected from the group consisting of lanthanum, cerium, praseodymium, neodymium, and yttrium.

The hydrate of a rare earth metal sulfate is represented by general formula (1):

M₂(SO₄)₃.nH₂O (1)

(in formula (1), M is at least one rare earth metal selected from the group consisting of La, Ce, Pr, Nd, and Y; n is greater than 0, and not more than 9).

The monohydrate of a rare earth metal sulfate represented by general formula (2) is more preferable.

M₂(SO₄)₃.1H₂O (2)

(in formula (2), M is at least one rare earth metal selected from the group consisting of La, Ce, Pr, Nd, and Y).

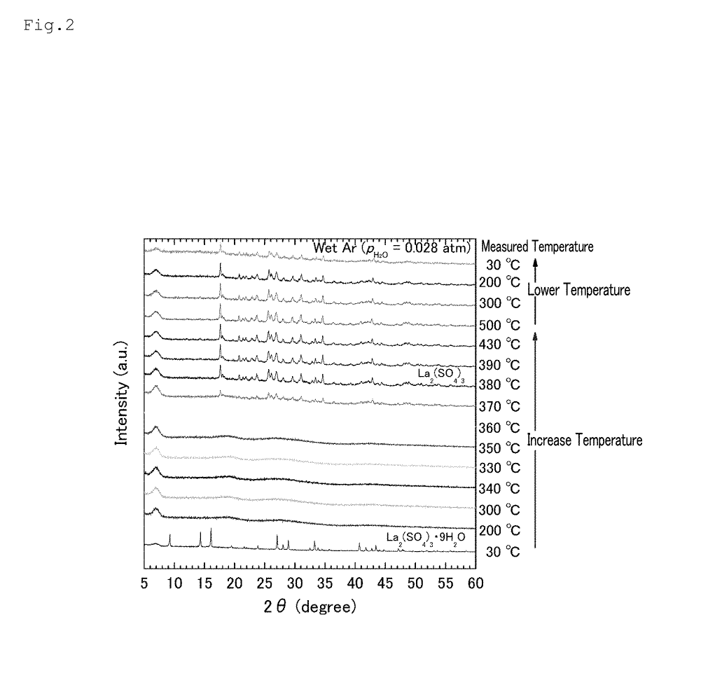

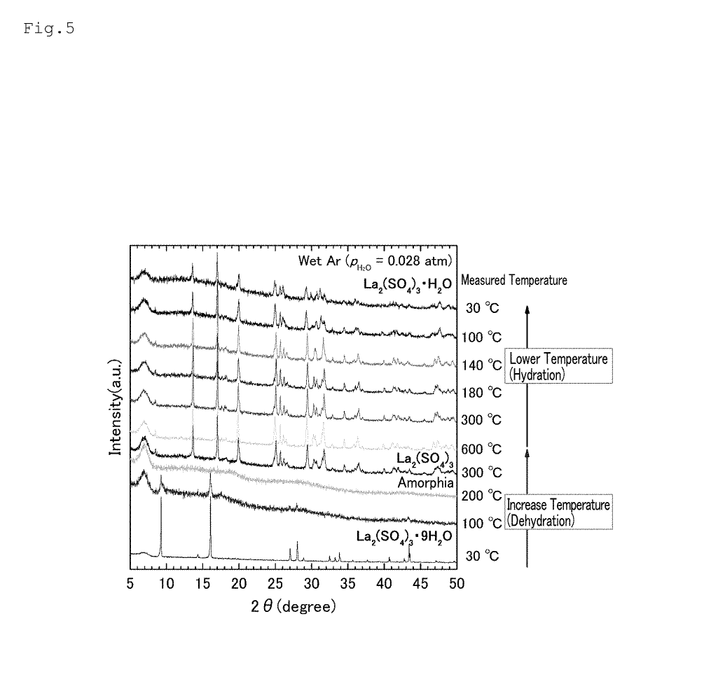

The hydrate of a rare earth metal sulfate of the present invention is identified by an X-ray diffraction (XRD) pattern that is measured using a copper radioactive ray of λ=1.5418 Å passed through a monochromator. According to such an X-ray diffraction pattern, the hydrate of a rare earth metal sulfate of the present invention has the peaks shown in FIG. 5; i.e., it has characteristic peaks at the following diffraction angles (2θ) (hereinbelow, the hydrate of a rare earth metal sulfate having the following peaks may also be referred to as a hydrate of β-phase rare earth metal sulfate). These peaks are characteristic peaks, which are different from the peaks in the X-ray diffraction pattern of the known rare earth metal sulfate (hereinbelow, this sulfate may be referred to as a α-phase rare earth metal sulfate), such as the one shown in FIG. 2.

Diffraction angles (2θ)
13.0 to 14.0°
16.5 to 17.5°
19.5 to 20.5°
24.5 to 25.5°
29.0 to 30.0°

More specifically, the hydrate has characteristic peaks at the following diffraction angles (2θ).
13.6°
17.0°
20.0°
25.0°
29.3°

Further, as shown in FIG. 5, the hydrate of a rare earth metal sulfate of the present invention also has peaks at the following diffraction angles (2θ), in addition to the above peaks.

Diffraction angles (2θ)
25.7°, 26.1°, 29.9°, 30.7°, 31.2°, and 31.8°

These diffraction angles (2θ) may have some errors of −0.5 to +0.5° depending on the measurement device, the measurement conditions, the type of rare earth metal, and the like. However, in the present invention, errors in this range are allowable.

Examples of the method for producing the hydrate of a rare earth metal sulfate of the present invention include a method comprising step (1) of heating a rare earth metal sulfate used as a raw material, or a hydrate of a rare earth metal sulfate that does not have the above peaks; and step (2) of performing cooling in the presence of water vapor. The rare earth metal sulfate used as a raw material, or the hydrate of a rare earth metal sulfate that does not have the above peaks, is not particularly limited. Examples include the α-phase rare earth metal sulfate or a hydrate thereof; rare earth metal sulfate amorphia etc.; commercially available rare earth metal sulfates or hydrates thereof; and the like. Specifically, a rare earth metal sulfate represented by general formula (1′):

M₂(SO₄)₃.mH₂O (1′)

(in formula (1′), M is as defined above, and m ranges from 0 to 9)

or a hydrate thereof may be used.

For example, when lanthanum is used as a rare earth metal, lanthanum sulfate nonahydrate (La₂(SO₄)₃.9H₂O), which is commercially available and easily obtainable, may be used.

Other examples include Y₂ (SO₄)₃.8H₂O, Ceₑ (SO₄)₃.9H₂O, Ceₑ (SO₄)₃.8H₂O, Ce₂ (SO₄)₃.5H₂O, Ceₑ (SO₄)₃.4H₂O, Pr₂ (SO₄)₃.8H₂O, Nd₂ (SO₄)₃.8H₂O, Nd₂ (SO₄)₃.5H₂O, Nd₂ (SO₄)₃.4H₂O, and the like.

The heating temperature in step (1) is preferably 200° C. or more, and more preferably 250° C. or more. By setting the heating temperature to 200° C. or more, efficient phase transition of rare earth metal sulfate to a β-phase may be performed.

Further, in tams of setting a temperature at which metal salts are not decomposed, suppression of unnecessary energy consumption, and suppression of side production of α-phase, the heating temperature in step (1) is preferably 1000° C. or less, more preferably 800° C. or less, and further preferably 600° C. or less.

Further, the temperature increase rate in the heating in step (1) is not particularly limited. For example, the temperature may be increased at a rate of about 0.1 to 50° C./min.

In step (1), since the dehydration reaction proceeds even in the presence of water vapor, a dehydration treatment or the like inside the reaction system is not particularly necessary.

The rare earth metal sulfate (anhydrous) may be obtained by performing cooling under a condition substantially free of water vapor after the heating in step (1).

Further, to obtain the hydrate of a rare earth metal sulfate of the present invention, a hydration reaction of a rare earth metal sulfate with water vapor is performed as step (2) after the heating step in step (1).

The hydration reaction of a rare earth metal sulfate with water vapor is preferably performed by lowering the temperature of the rare earth metal sulfate obtained after the heating step in step (1) in the presence of water vapor to preferably about 20 to 300° C., more preferably about 20 to 200° C., and further preferably about 20 to 100° C., in terms of ensuring a rapid hydration reaction and an increase in hydration number. Further, although the temperature decrease rate is not particularly limited, the temperature is preferably lowered, for example, at a decrease rate of 0.1 to 50° C./min.

The partial pressure of the water vapor is not particularly limited. The reaction will proceed at about the pressure of atmospheric vapor. Specifically, the partial pressure is generally about 0.001 to 1 atm, preferably about 0.005 to 1 atm.

The pressure in the whole reaction system for performing the hydration and dehydration reactions is, for example, atmospheric pressure. The pressure may be appropriately adjusted.

By further dehydrating the hydrate of a rare earth metal sulfate obtained by the above method, anhydrous rare earth metal sulfate may be obtained. The dehydration reaction is performed by heating the hydrate of a rare earth metal sulfate. The heating is preferably performed by increasing the temperature to preferably about 80 to 300° C., more preferably about 150 to 300° C., further preferably about 200 to 300° C., in terms of ensuring a rapid dehydration reaction and efficient production of anhydrous rare earth metal sulfuric acid. Further, although the temperature increase rate is not particularly limited, the temperature may be increased, for example, at an increase rate of about 0.1 to 50° C./min.

The hydrate of a rare earth metal sulfate of the present invention, and the rare earth metal sulfate enable reversible hydration/dehydration reactions in the presence of water vapor at a temperature range required in industrial use (for example, about 100 to 250° C.)

Therefore, the hydrate of a rare earth metal sulfate of the present invention may be useful for a chemical heat storage material.

Further, a rare earth metal sulfate (anhydrous) having the above β-phase, which is represented by general formula (A):

M₂(SO₄)₃ (A)

(in formula (A), M is at least one rare earth metal selected from the group consisting of La, Ce, Pr, Nd, and Y) may also be useful for a chemical heat storage material.

When a rare earth metal sulfate (anhydrous) having a β-phase is used as a chemical heat storage material, heat dissipation can be performed not only by a reaction with water vapor, but also by a reaction with liquid water (see Examples 6 and 7).

### EXAMPLES

The present invention is more specifically described below with reference to Examples and Comparative Examples. However, the present invention is not limited to the following embodiments.

### Reference Example 1: Measurement of Thermogravimetry (TG) of α-Phase Lanthanum Sulfate

A lanthanum sulfate nonahydrate (Wako Pure Chemical Industries, Ltd.) was pulverized using a ball mill until the average particle size was 2 μm or less. The lanthanum sulfate nonahydrate thus pulverized to have an average particle size of 2 μm or less was heated to 600° C. at a temperature increase rate of 20° C./min, using a thermogravimetry (TG) measurement device (TG8120: Rigaku Corporation); thereafter, the temperature was lowered to 50° C. at a temperature decrease rate of 2° C./min (first scanning). In this specification, the average particle size is a value obtained by a known measurement method (for example, measurement using a scanning electron microscope image).

Subsequently, the temperature was increased to 300° C. at a temperature increase rate of 2° C./min, and the temperature was lowered to 30° C. at a temperature decrease rate of 2° C./min (second scanning).

The inside of the TG device was controlled by distributing humidified argon (Ar) gas inside the device by performing Ar gas-bubbling in water at a constant temperature (Ar (P_{H2O}=0.0086 atm), flow rate: 200 sccm).

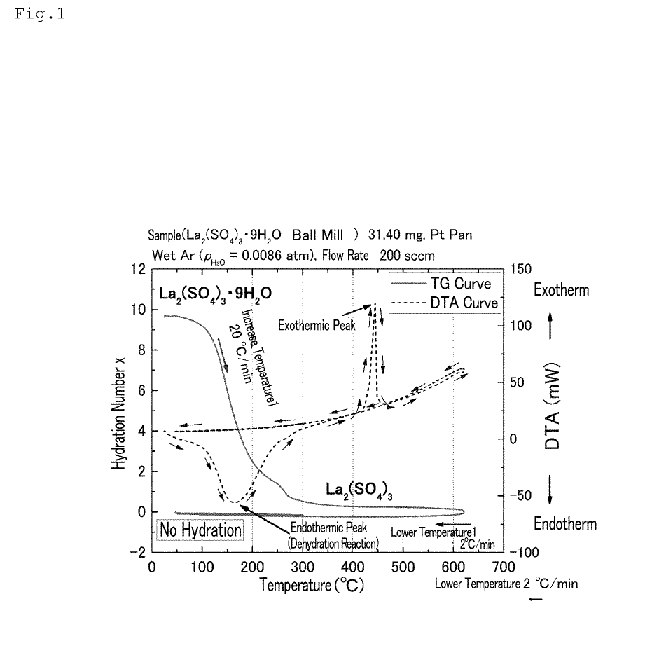

FIG. 1 shows the TG measurement results. In FIG. 1, the solid line denotes a TG curve, and the broken line denotes a DTA curve. The horizontal axis of the graph shows temperature, the left vertical axis of the graph shows hydration number obtained from weight change in the TG curve, and the right vertical axis shows the exotherm/endotherm amount in the DTA curve.

FIG. 1 shows that the lanthanum sulfate nonahydrate having the average particle size of 2 μm or less obtained in Reference Example 1 undergoes dehydration at around 80° C., and becomes almost anhydrous at around 300° C. Further, FIG. 1 also revealed that, once the lanthanum sulfate is dehydrated (having a α-phase according to Reference Example 2), it will not be hydrated when the temperature is lowered, even in the humidified Ar gas atmosphere.

### Reference Example 2: High-Temperature X-Ray Diffraction (XRD) Measurement of α-Phase Lanthanum Sulfate

A lanthanum sulfate nonahydrate (Wako Pure Chemical Industries, Ltd.) was pulverized using a ball mill until the average particle size was 2 μm or less, in a manner similar to that of Reference Example 1. The lanthanum sulfate nonahydrate thus pulverized to have an average particle size of 2 μm or less was heated to 500° C. at a temperature increase rate of 20° C./min; thereafter, the temperature was lowered to 30° C. at a temperature decrease rate of 20° C./min. The inside of the device was controlled by distributing humidified Ar gas inside the device by performing Ar gas-bubbling in water at a constant temperature (Ar (P_{H2O}=0.028 atm), flow rate: 200 sccm).

The X-ray diffraction patterns of sulfuric acid lanthanum sulfate and a hydrate thereof at the temperatures shown in Table 2 during the temperature increasing and lowering steps were measured using a high-temperature X-ray diffraction (XRD) device (X'pert PRO, PANalytical). The high-temperature XRD was measured using a copper radioactive ray of λ=1.5418 Å passed through a monochromator.

Table 2 shows the diffraction angles in relation to the characteristic peaks obtained in X-ray diffraction pattern at the various temperatures, and FIG. 2 shows an X-ray diffraction pattern. In FIG. 2, the horizontal axis denotes diffraction angle (2θ), the left vertical axis denotes diffraction strength, and the right vertical axis denotes measurement temperature of each measurement graph. Table 2 and FIG. 2 reveal that a lanthanum sulfate having the known crystal structure (this sulfate is referred to as an α-phase lanthanum sulfate in this specification) is generated at around 380° C. in the temperature increasing step, and that the α-phase crystal structure was also maintained in the temperature lowering step.

TABLE 2

| | Temperature | Diffraction Angle |
|---|---|---|
| | (° C.) | (2θ) (°) |
| Temperature | 30 | 9.3, 14.3, 16.1, 19.5, 21.6, 23.9, 27.0, |
| Increasing | (La₂(SO₄)₃•9H₂O) | 28.0, 28.9, 32.5, 33.2, 33.8, 34.5, 35.7, |
| Step | | 37.7, 39.4 |
| | 380 | 17.7, 18.0, 20.8, 21.4, 21.9, 22.9, 23.7, |
| | | 25.7, 26.1, 26.9, 28.1 29.6, 31.0, 32.9, |
| | | 33.4, 33.9, 34.6, 36.4, 37.6 39.3 |
| | 390 | 17.6, 17.9, 20.7, 21.4, 21.9, 22.8, 23.8, |
| | | 25.6, 26.1, 26.9, 28.0, 29.6, 31.0, 32.0, |
| | | 32.9, 33.4, 33.9, 34.6 36.5 37.6, 39.3 |
| | 430 | 14.2, 17.6, 18.0, 19.8, 20.8, 21.4, 21.9, |
| | | 22.8, 23.7, 25.6, 26.1, 26.9, 28.1, 29.6, |
| | | 31.0, 32.0, 32.9, 33.4, 34.6, 36.4, 37.6, |
| | | 39.3 |
| | 500 | 17.6, 17.9, 20.7, 21.4, 21.8, 22.8, 23.7, |
| | | 25.6, 26.1, 26.9, 28.0, 29.6, 31.0, 32.0, |
| | | 32.9, 33.4, 33.9, 34.6, 36.4, 37.6, 39.2 |
| Temperature | 300 | 17.6, 18.0, 20.8, 21.5, 21.9, 22.9, 23.7, |
| Lowering | | 25.7, 26.1, 26.9, 28.1, 29.7, 31.0, 32.9, |
| Step | | 33.4, 34.7, 36.5, 37.6, 39.3 |
| | 200 | 17.7, 20.8, 21.5, 21.9, 22.9, 23.8, 25.7, |
| | | 26.1, 26.9, 28.2, 29.7, 31.1, 33.0, 33.5, |
| | | 34.6, 36.5, 37.6, 39.4 |
| | 30 | 17.7, 20.8, 21.5, 22.0, 23.8, 25.7, 27.0, |
| | | 28.2, 29.7, 31.1, 33.6, 34.7, 36.6 |

### Example 1: Thermogravimetry (TG) Measurement of β-Phase Lanthanum Sulfate and β-Phase Lanthanum Sulfate Hydrate

The lanthanum sulfate nonahydrate (Wako Pure Chemical Industries, Ltd.) was used without being pulverized. The lanthanum sulfate nonahydrate was heated to 600° C. at a temperature increase rate of 20° C./min using a thermogravimetry (TG) measurement device (the same device as that used above); thereafter, the temperature was lowered to 50° C. at a temperature decrease rate of 2° C./min (first scanning).

Subsequently, the temperature was increased to 300° C. at a temperature increase rate of 0.2° C./min, and the temperature was lowered to 30° C. at a temperature decrease rate of 0.2° C./min (second scanning).

The inside of the TG device was controlled by distributing humidified argon (Ar) gas inside the device by performing Ar gas-bubbling in water at a constant temperature (Ar (P_{H2O}=0.023 atm), flow rate: 200 sccm).

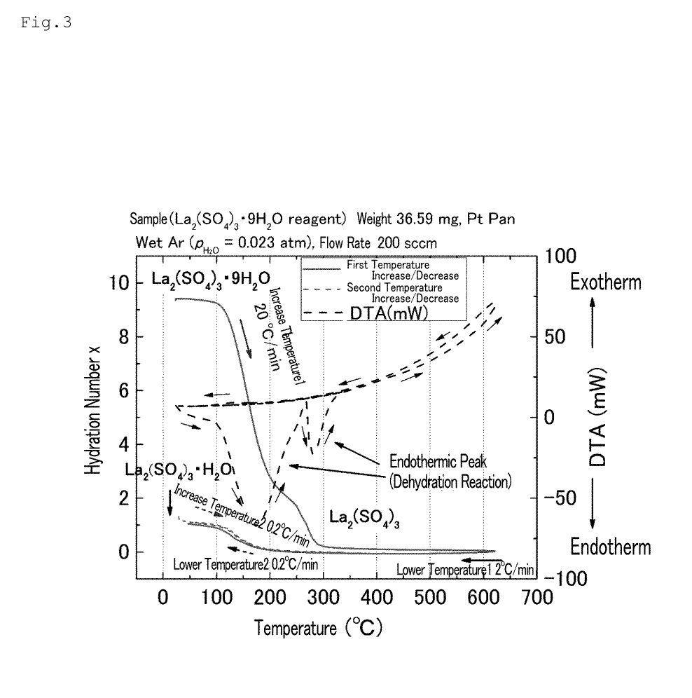

FIG. 3 shows the TG measurement results. In FIG. 3, the solid line denotes a TG curve in the first scanning, the narrow broken line denotes a TG curve in the second scanning, and the wide broken line denotes a DTA curve. Further, the horizontal axis of the graph denotes temperature, the left vertical axis of the graph denotes hydration number obtained from weight change in the TG curve, and the right vertical axis denotes the exotherm/endotherm amount in the DTA curve.

The TG measurement results during the temperature increasing step in the first scanning in FIG. 3 revealed that the lanthanum sulfate nonahydrate of Example 1 underwent dehydration at around 80 to 250° C., and became almost anhydrous at around 300° C. It was, thereafter, further revealed that the weight was also increased in the temperature lowering step in the first scanning, in the same temperature range as that in the temperature increasing step; and, according to FIG. 3, it was revealed that a lanthanum sulfate monohydrate was formed. By X-ray diffraction measurement, the anhydrous matter and the monohydrate were confirmed to have a β-phase (Example 2).

Further, the temperature increasing/lowering step in the second scanning in FIG. 3 revealed that the β-phase lanthanum sulfate monohydrate underwent dehydration/hydration reactions, and that the behavior was substantially the same as that in the temperature lowering step in the first scanning. Further, the temperature hysteresis of the dehydration/hydration reactions was within 10° C.

This shows that, in the reaction formula represented by the following general formula,

La₂(SO₄)₃.H₂O [symbol] La₂(SO₄)₃+H₂O

the dehydration/hydration reactions reversibly proceed at a required temperature range (around 100 to 250° C.)

The TG curve in the second scanning shown in FIG. 3 shows the relationship: dehydration start temperature<hydration start temperature. If the dehydration/hydration reactions occur between two phases, i.e., between an anhydrous matter and a monohydrate, the relationship will be as follows: hydration start temperature≤equilibrium temperature≤dehydration start temperature. Therefore, it is suggested that the reactions proceed in the state of a single phase La₂(SO₄)₃.xH₂O with successive changes of hydration number x.

Therefore, La₂(SO₄)₃/H₂O system is a prospective chemical heat storage material.

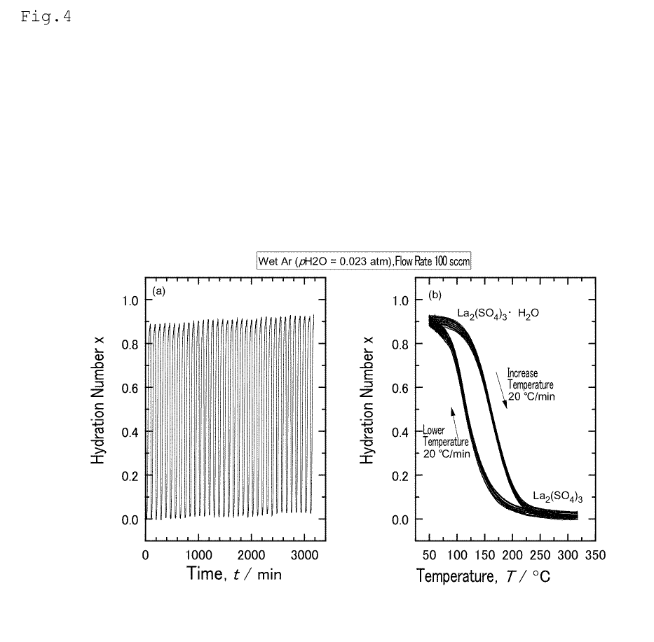

FIG. 4 shows a TG curve when a temperature increasing/lowering step with respect to a β-phase lanthanum sulfate monohydrate was repeated 35 times in the temperature range of 50 to 300° C. at a temperature increase/decrease rate of 20° C./min. In FIG. 4(a), the horizontal axis denotes time, and the vertical axis denotes hydration number. In FIG. 4(b), the horizontal axis denotes temperature, and the vertical axis denotes hydration number. As shown in FIG. 4, it was confirmed that the behavior of the dehydration/hydration reactions were the same as those in the temperature increasing/lowering step in the second scanning in FIG. 3, even when the temperature increasing/lowering step was repeated 35 times.

### Example 2: High-Temperature X-Ray Diffraction (XRD) Measurement of β-Phase Lanthanum Sulfate and β-Phase Lanthanum Sulfate Hydrate

As in Example 1, a lanthanum sulfate nonahydrate (Wako Pure Chemical Industries, Ltd.) was heated to 500° C. at a temperature increase rate of 20° C./min. Thereafter, the temperature was lowered to 30° C. at a temperature decrease rate of 20° C./min. The inside of the device was controlled by distributing humidified Ar gas inside the device by performing Ar gas-bubbling in water at a constant temperature (Ar (P_{H2O}=0.028 atm), flow rate: 200 sccm).

The X-ray diffraction pattern of sulfuric acid lanthanum sulfate and a hydrate thereof at the various temperatures shown in Table 3 in the temperature increasing and lowering steps were measured using a high-temperature X-ray diffraction (XRD) device (the same device as that used above). The high-temperature XRD was measured using a copper radioactive ray of λ=1.5418 Å passed through a monochromator.

Table 3 shows the diffraction angles in relation to the peaks obtained in X-ray diffraction pattern at the various temperatures, and FIG. 5 shows an X-ray diffraction pattern. In FIG. 5, the horizontal axis denotes diffraction angle (2θ), the left vertical axis denotes diffraction strength, and the right vertical axis denotes measurement temperature of each measurement graph.

TABLE 3

| | Temperature | Diffraction Angle |
|---|---|---|
| | (° C.) | (2θ) (°) |
| Temperature | 30 | 9.3, 14.3, 16.1, 19.5, 27.0, 28.0, 28.9, |
| Increasing | (La₂(SO₄)₃•9H₂O) | 32.5, 33.2, 33.8, 35.7, 37.7 |
| Step | 300 | 8.5, 13.7, 17.1, 18.1, 19.9, 25.1, 25.7, |
| | | 26.2, 26.6, 29.4, 30.3, 30.7, 31.7, 32.9, |
| | | 34.5, 36.5 |
| | 600 | 8.5, 13.7, 17.0, 18.2, 19.9, 25.0, 25.7, |
| | | 26.1, 26.5, 29.3, 30.2, 30.5, 31.6, 32.9, |
| | | 34.5, 35.8, 36.4, 37.0 |
| Temperature | 300 | 8.5, 13.7, 17.0, 17.6, 18.1, 19.9, 24.8, |
| Lowering | | 25.1, 25.7, 26.2, 26.6, 29.4, 30.3, 30.7, |
| Step | | 31.4, 31.7, 32.9, 34.5, 36.0, 36.5 |
| | 180 | 13.7, 17.1, 18.2, 19.9, 24.8, 25.1, 25.7, |
| | | 26.2, 26.7, 29.5, 30.3, 30.7, 31.5, 31.7, |
| | | 34.5, 36.0, 36.5 |
| | 140 | 13.7, 17.1, 18.2, 20.0, 25.1, 25.7, 26.1, |
| | | 26.6, 29.4, 30.4, 31.6, 32.9, 34.5, 35.8, |
| | | 36.4 |
| | 100 | 13.6, 17.0, 20.0, 25.0, 25.7, 26.0, 29.3, |
| | | 30.6, 31.3, 31.7, 32.8, 34.5, 36.4 |
| | 30 | 13.6, 17.0, 20.0, 24.9, 25.7, 26.0, 29.3, |
| | | 29.9, 30.7, 31.2, 31.8, 34.5, 36.0 |

The results of Table 3 revealed that characteristic peaks were observed at 13.7°, 17.1°, 19.9°, 25.1°, and 29.4°, at around 300° C. in the temperature increasing step. These peaks were also commonly observed in the subsequent temperature increasing steps and the temperature lowering steps. The results suggest that the hydration proceeds while maintaining the crystal structure. Further, such characteristic peaks were not observed in the lanthanum sulfate nonahydrate used as a raw material, or in the α-phase lanthanum sulfate or a hydrate thereof of Reference Example 2 (Table 2).

The above results confirmed that a lanthanum sulfate and a lanthanum sulfate hydrate having a β-phase crystal structure, which is different from α-phase, were obtained in Example 2.

### Example 3: Dehydration/Hydration Behaviors of β-Phase Lanthanum Sulfate Hydrates Having Various Average Particle Sizes

The lanthanum sulfate nonahydrate (Wako Pure Chemical Industries, Ltd.) was dissolved in deionized water to prepare a saturated aqueous solution. The obtained saturated aqueous solution was kept at 40° C., thereby precipitating crystals in the solution. The obtained crystals have an average particle size of about 8 mm.

The obtained lanthanum sulfate nonahydrate crystals were heated to 600° C. at a temperature increase rate of 20° C./min using a thermogravimetry (TG) measurement device (the same device as that used above); thereafter, the temperature was lowered to 50° C. at a temperature decrease rate of 20° C./min (first scanning).

Subsequently, the temperature was increased to 300° C. at a temperature increase rate of 1° C./min, and then lowered to 50° C. at a temperature decrease rate of 1° C./min (second scanning).

The inside of the TG device was controlled by distributing humidified argon (Ar) gas inside the device by performing Ar gas-bubbling in water at a constant temperature.

Further, a lanthanum sulfate nonahydrate (Wako Pure Chemical Industries, Ltd.) was subjected to a temperature increasing/lowering step in a manner similar to that above directly in the form of powder (the average particle size=about 20 μm) without being subjected to the above dissolution and crystal precipitation.

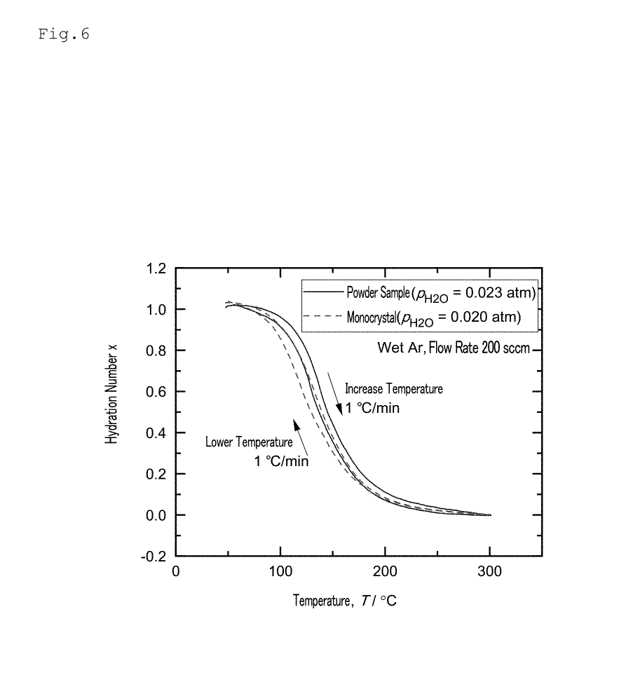

FIG. 6 shows the TG measurement results. In FIG. 6, the graph shows TG curves in the second scanning, the solid line denotes a TG curve of the lanthanum sulfate monohydrate obtained by using a lanthanum sulfate nonahydrate in the commercially available powder form, and the broken line denotes a TG curve of the lanthanum sulfate monohydrate obtained by using crystals of lanthanum sulfate nonahydrate. The horizontal axis of the graph denotes temperature, and the vertical axis denotes hydration number obtained from weight change.

The results of FIG. 6 revealed no large difference in the dehydration/hydration reaction speed despite the difference in average particle size, more specifically, the difference in surface area, of the samples. This is considered to be attributable to the rapid surface reaction speed and diffusion speed of water molecules hydrated with the lanthanum sulfate, which is therefore not the rate-determining process.

### Example 4: P_{H2O} Dependency of β-Phase Lanthanum Sulfate Hydrate

A lanthanum sulfate monohydrate was heated to 300° C. at a temperature increase rate of 0.2° C./min using a thermogravimetry (TG) measurement device (the same device as that used above); thereafter, the temperature was lowered to 30° C. at a temperature decrease rate of 0.2° C./min.

The inside of the TG device was controlled by distributing humidified argon (Ar) gas inside the device by performing Ar gas-bubbling in water at a constant temperature (flow rate: 200 sccm). The partial pressure (P_{H2O}) of the water vapor was measured at 0.0024 atm, 0.0086 atm, 0.0168 atm, and 0.0231 atm.

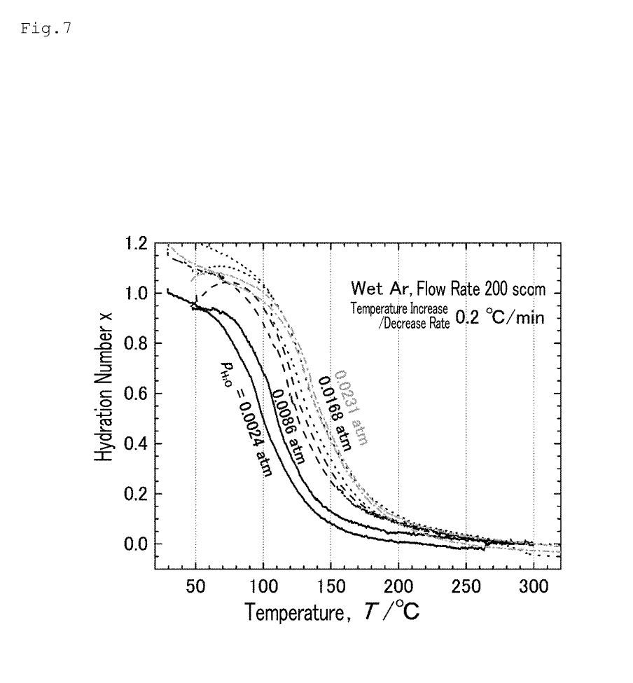

FIG. 7 shows the TG measurement results. The horizontal axis of the graph denotes temperature, and the vertical axis of the graph denotes hydration number obtained from weight change in the TG curve.

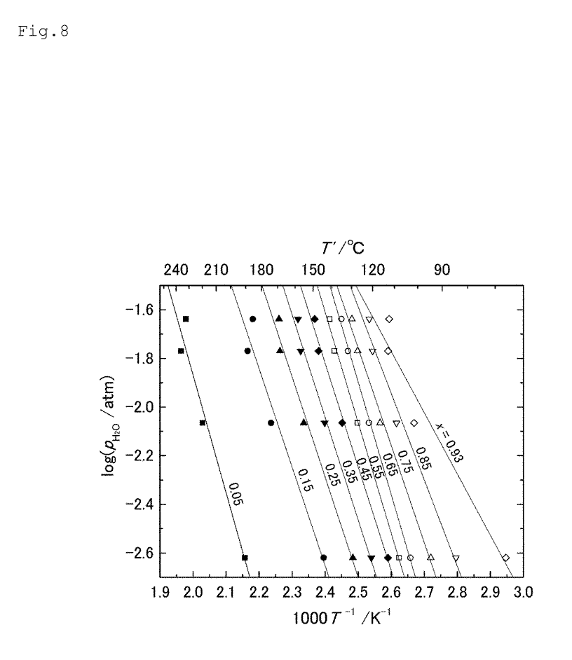

The relationship between vapor partial pressure and dehydration temperature was plotted for each hydration number x according to the results upon the temperature increase in the TG measurement shown in FIG. 7. FIG. 8 shows the graph. The following van't Hoff's equation was substituted according to the value of the inclination of the straight line shown in FIG. 8, thereby determining a differential standard enthalpy change: ΔH° (x) (per unit of dehydration amount) of the dehydration reaction for each hydration number x.

$$ln ( {p}_{H 2 O} ( x ) ) = - \frac{Δ H° ( x )}{R} \cdot \frac{1}{T} + \frac{Δ S° ( x )}{R}$$

Further, as shown below, the integration of ΔH° (x) was performed for the compositions between the anhydrous matter and the monohydrate, thereby determining the standard enthalpy change (ΔH°ₜₒₜₐₗ) in the dehydration reaction from the lanthanum sulfate monohydrate to the anhydrous lanthanum sulfate.

ΔHₜₒₜₐₗ°=∫₀ΔH°(x)dx

The calculation result of the above equation was ΔH°ₜₒₜₐₗ=77 kJ/mol.

The normalization by the volume by assuming a dense body of a monohydrate derives 0.46 GJ/m³. This provides a volume heat storage density similar to the substantial volume heat storage density of MgO/H₂O system (J. Ryu et al., Chem. Lett., 37 (2008) 1140).

### Example 5: Thermogravimetry (TG) Measurement of β-Phase Cerium Sulfate and β-Phase Cerium Sulfate Hydrate

0.5 g of CeO₂ (Wako Pure Chemical Industries, Ltd., purity: 99.9%) and 36 g of H₂SO₄ (Nacalai Tesque, Inc., purity: 97%) were mixed, and the mixture was stirred for about 5 days while heating with a hot stirrer set to 200° C. Since orange precipitation and supernatant liquid were observed at a liquid amount of 25 ml, deionized water was added for dilution. As a result, the precipitates were completely dissolved at a total amount of 150 mL. The heating was performed again with a hot stirrer set to 100° C., thereby evaporating the moisture. The resulting liquid amount was about 50 ml, and needle-like transparent crystals were generated. The supernatant liquid was removed, and the crystals were washed with propanol and dried at 50° C. The obtained crystals were cerium sulfate pentahydrate Ce₂ (SO₄)₃.5H₂O (containing a small amount of tetrahydrate) having a different crystal structure from that of β-phase.

The cerium sulfate pentahydrate was heated to 600° C. at a temperature increase rate of 20° C./min using a thermogravimetry (TG) measurement device (the same device as that used above); thereafter, the temperature was lowered to 50° C. at a temperature decrease rate of 2° C./min (first scanning).

Subsequently, the temperature was increased to 600° C. at a temperature increase rate of 2° C./min, and then lowered to 50° C. at a temperature decrease rate of 2° C./min (second scanning).

The inside of the TG device was controlled by distributing humidified argon (Ar) gas inside the device by performing Ar gas-bubbling in water at a constant temperature (Ar (P_{H2O}=0.020 atm), flow rate: 200 sccm).

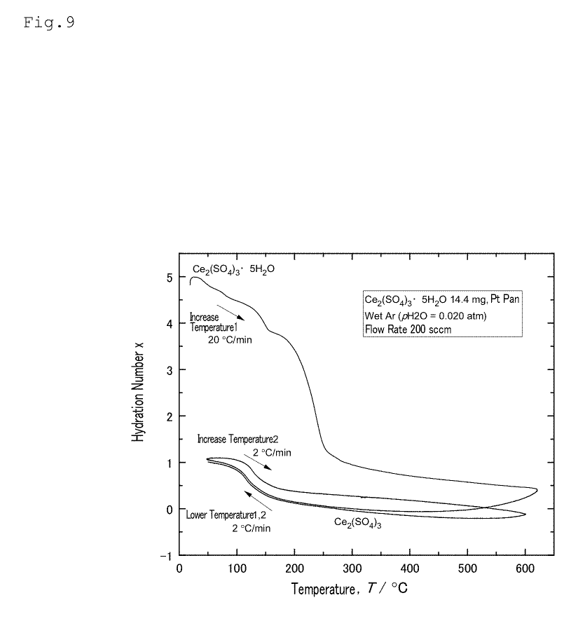

FIG. 9 shows the TG measurement results. In FIG. 9, the solid line denotes a TG curve in the first or second scanning. The horizontal axis of the graph denotes temperature, and the left vertical axis of the graph denotes hydration number obtained from weight change in the TG curve.

The TG measurement results during the temperature increasing step in the first scanning in FIG. 9 revealed that the cerium sulfate pentahydrate underwent dehydration at 30 to 250° C., and after the temperature reached 600° C., it became almost anhydrous at around 300° C. in the temperature lowering step. It was, thereafter, further revealed that the weight was also increased at 300 to 50° C., and that a cerium sulfate monohydrate was formed.

Further, the temperature increasing/lowering step in the second scanning in FIG. 9 revealed that the cerium sulfate monohydrate underwent dehydration/hydration reactions at around 50 to 300° C., and that the behavior was substantially the same as that in the temperature lowering step in the first scanning.

The X-ray diffraction measurement at room temperature (25° C.) revealed that the cerium sulfate monohydrate after the TG measurement had a β-phase.

### Comparative Example 1: Thermogravimetry (TG) Measurement of Magnesium Hydroxide

A magnesium hydroxide was heated to 420° C. at a temperature increase rate of 20° C./min using a thermogravimetry (TG) measurement device (the same device as that used above); thereafter, the temperature was lowered to 50° C. at a temperature decrease rate of 20° C./min.

The inside of the TG device was controlled by distributing humidified argon (Ar) gas inside the device by performing Ar gas-bubbling in water at a constant temperature (Ar (P_{H2O}=0.020 atm), flow rate: 200 sccm).

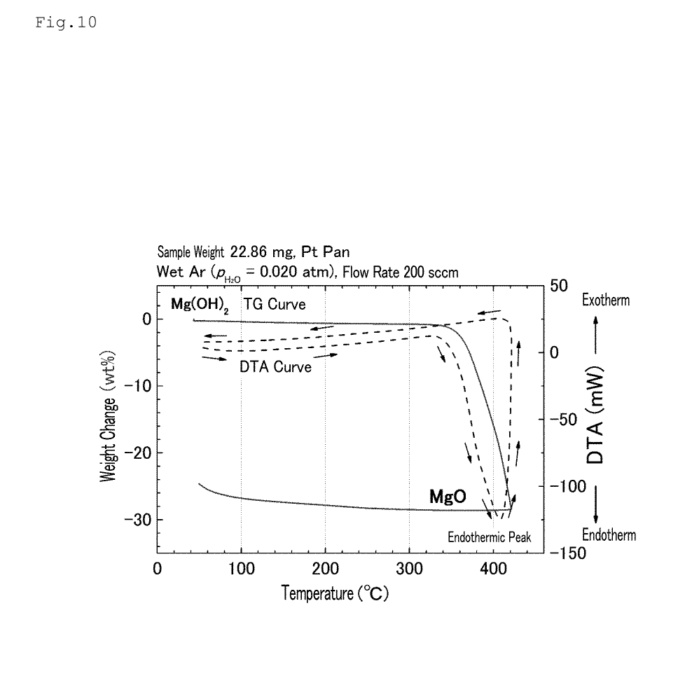

FIG. 10 shows the TG measurement results. In FIG. 10, the solid lines denote a TG curve, and the broken lines denote a DTA curve. Further, the horizontal axis of the graph denotes temperature, the left vertical axis of the graph denotes weight change in the TG curve, and the right vertical axis denotes the exotherm/endotherm amount in the DTA curve.

The results of the TG measurement in the temperature increasing step shown in FIG. 10 revealed that the dehydration of the magnesium hydroxide in Comparative Example 1 was started at around 330° C. This indicates that the dehydration reaction starting temperature was significantly high. Further, the results of the temperature lowering step indicates behavior such that the hydration reaction was started at around 120° C.; however, it was confirmed that the hydration reaction did not proceed completely, and that the hydration rate was extremely low.

### Example 6: β-Phase Anhydrous Lanthanum Sulfate+Water Vapor→β-Phase Lanthanum Sulfate Hydrate

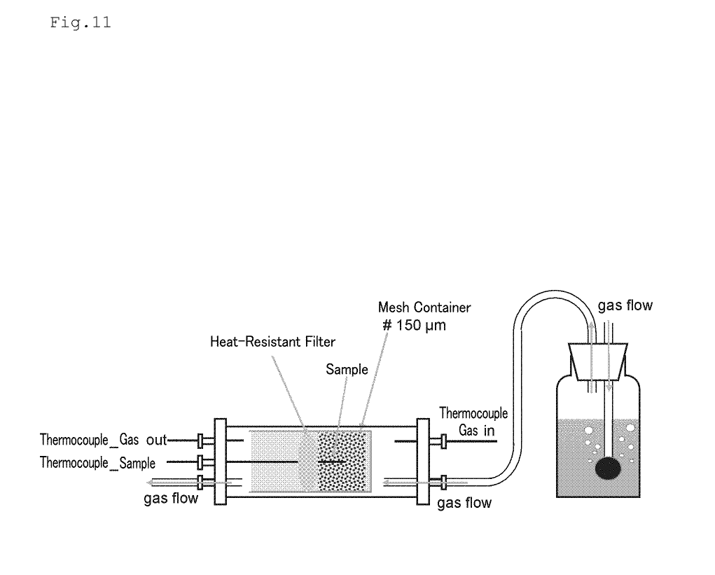

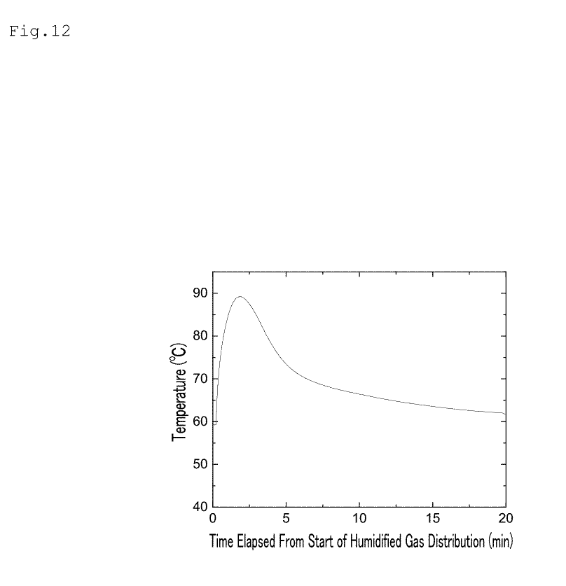

As shown in FIG. 11, about 25 g of β-phase lanthanum sulfate (anhydrous) powder was placed in a stainless-steel mesh container (opening size: 150 μm, outer diameter: 34 mm, length: 70 mm), and then the powder in the container was placed in a cylindrical stainless-steel reactor (inner diameter: 35 mm, length: 130 mm). The reactor was placed in a constant-temperature furnace at 60° C., and humidified air (partial water vapor pressure=P_{H2O}=0.16 atm) having the same temperature was supplied to the reactor at 1.5 L/min. The temperature change of the sample over time after the humidified air was supplied was measured using a thermocouple placed in the sample portion. FIG. 12 shows the results. FIG. 12 confirmed that the temperature of the sample increased to near 90° C. in about 2 minutes after the humidified air was supplied, and that heat was generated by the reaction of β-phase lanthanum sulfate with water vapor.

### Example 7: β-Phase Anhydrous Lanthanum Sulfate+Water (Liquid Form)→Lanthanum Sulfate Nonahydrate

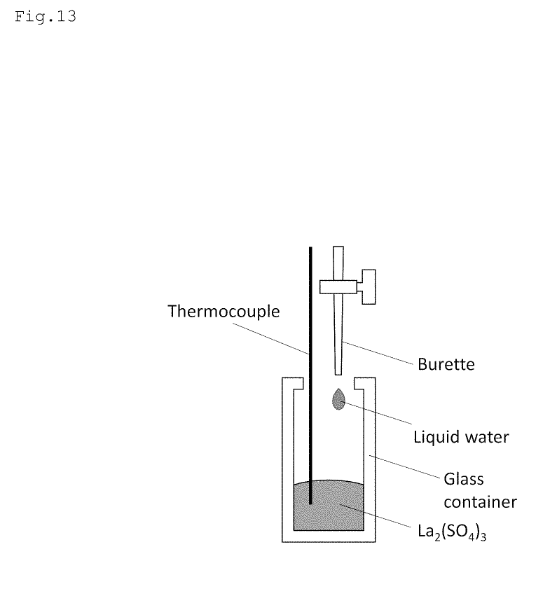

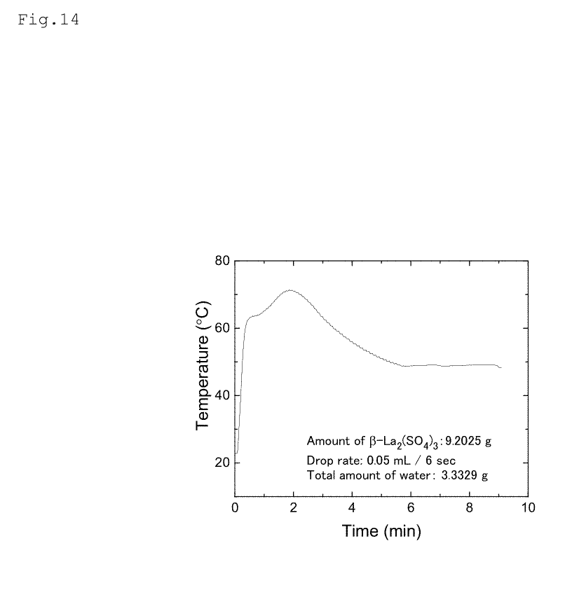

As shown in FIG. 13, about 9 g of β-phase lanthanum sulfate (anhydrous) powder was placed in a cylindrical glass container, and room-temperature water was added dropwise at a constant speed. The temperature change of the sample over time after the water was supplied was measured using a thermocouple placed in the sample portion. FIG. 14 shows the results. FIG. 14 confirmed that the temperature of the sample increased to near 70° C. in about 2 minutes after the water (liquid) was supplied, and that heat was generated by the reaction of β-phase lanthanum sulfate with water.

### INDUSTRIAL APPLICABILITY

The hydrate of a rare earth metal sulfate of the present invention, and the rare earth metal sulfate enable reversible hydration/dehydration reactions in the presence of water vapor at a temperature range required in industrial use (e.g., about 100 to 250° C.).

Therefore, the hydrate of a rare earth metal sulfate of the present invention is useful for a chemical heat storage material. Such a chemical heat storage material is expected to be applied to a stationary heat storage device (e.g., a chemical heat pump) and a stored heat conveying system.

1. A hydrate of a rare earth metal sulfate having characteristic peaks at the following diffraction angles (2θ) in an X-ray diffraction pattern, which is measured using a copper radioactive ray of λ=1.5418 Å passed through a monochromator:
Diffraction angles (2θ) at
13.0 to 14.0°,
16.5 to 17.5°,
19.5 to 20.5°,
24.5 to 25.5°, and
29.0 to 30.0°.

2. The hydrate of a rare earth metal sulfate according to claim 1, wherein the rare earth metal is at least one member selected from the group consisting of lanthanum, cerium, praseodymium, neodymium, and yttrium.

3. The hydrate of a rare earth metal sulfate according to claim 1, represented by general formula (1):
M₂(SO₄)₃.nH₂O (1)
(in formula (1), M is at least one rare earth metal selected from the group consisting of La, Ce, Pr, Nd, and Y; n is greater than 0, and not more than 9).

4. The hydrate of a rare earth metal sulfate according to claim 1, wherein the hydrate of a rare earth metal sulfate is a monohydrate of a rare earth metal sulfate.

5. A hydrate of a rare earth metal sulfate, represented by general formula (2):
M₂(SO₄)₃.1H₂O (2)
(in formula (2), M is at least one rare earth metal selected from the group consisting of La, Ce, Pr, Nd, and Y).

6. A chemical heat storage material comprising the hydrate of a rare earth metal sulfate according to claim 1, and further comprising a rare earth metal sulfate having characteristic peaks at the following diffraction angles (2θ) in an X-ray diffraction pattern, which is measured using a copper radioactive ray of λ=1.5418 Å passed through a monochromator:
Diffraction angles (2θ) at
13.0 to 14.0°,
16.5 to 17.5°,
19.5 to 20.5°,
24.5 to 25.5°, and
29.0 to 30.0°.

7. A method for producing a hydrate of a rare earth metal sulfate having characteristic peaks at the following diffraction angles (2θ) in an X-ray diffraction pattern, which is measured using a copper radioactive ray of λ=1.5418 Å passed through a monochromator, the method comprising:
step (1) of heating a rare earth metal sulfate, or a hydrate of a rare earth metal sulfate that does not have the peaks, to 200° C. or more; and
step (2) of lowering the temperature of the rare earth metal sulfate obtained in step (1) in the presence of water vapor:
Diffraction angles (2θ) at
13.0 to 14.0°,
16.5 to 17.5°,
19.5 to 20.5°,
24.5 to 25.5°, and
29.0 to 30.0°.

8. A method for producing a monohydrate of a rare earth metal sulfate, comprising:
step (1) of heating a rare earth metal sulfate, or a hydrate of a rare earth metal sulfate that does not have characteristic peaks at the diffraction angles (2θ) specified in claim 7 in an X-ray diffraction pattern, which is measured using a copper radioactive ray of λ=1.5418 Å passed through a monochromator, to 200° C.; and
step (2) of lowering the temperature of the rare earth metal sulfate obtained in step (1) in the presence of water vapor.

9. The method according to claim 7, wherein the rare earth metal is at least one member selected from the group consisting of lanthanum, cerium, praseodymium, neodymium, and yttrium.
